(19) United States
(12) Patent Application Publication
(10) Pub. No.: US 2026/0259596 A1
(43) Pub. Date: Sep. 3, 2026

(54) DEGREE-OF-FREEDOM CONTROL IN XR EXPERIENCES

(71) Applicant: InterDigital CE Patent Holdings, SAS, Paris (FR)

(72) Inventors: Patrice Hirtzlin, Betton (FR); Gurdeep Bhullar, Montreal (CA); Pierrick Jouet, Rennes (FR); Sylvain Lelievre, Montgermont (FR); Etienne Faivre d'Arcier, Saint Gonlay (FR); Loic Fontaine, Noyal sur Vilaine (FR)

(73) Assignee: InterDigital CE Patent Holdings, SAS, Paris (FR)

(21) Appl. No.: 18/876,014

(22) PCT Filed: Jun. 16, 2023
(86) PCT No.: PCT/EP2023/066331

§ 371 Date: Dec. 17, 2024

(30) Foreign Application Priority Data
Jun. 17, 2022 (EP) 22305881.9

(51) Int. Cl. G06F 3/01

(52) U.S. Cl. CPC G06F 3/011

(57) ABSTRACT

Systems, methods, and instrumentalities are disclosed for degree-of-freedom (DoF) control in extended reality (XR) experiences. In examples, a device may determine a first elementary degree of freedom (DoF) boundary associated with a user. The first elementary DoF boundary may be determined based on at least one of prior-to-runtime information or runtime information. The device may determine a second elementary DoF boundary associated with the user based on at least the prior-to-runtime information or the runtime information. The device may determine a consolidated DoF boundary based on the first elementary DoF boundary and the second elementary DoF boundary. On a condition that the determination of the consolidated DoF boundary is successful, the device may determine to control a movement of the user based on the consolidated boundary.

### CROSS REFERENCE TO RELATED APPLICATIONS

This application claims the benefit of European Provisional Patent Application No. 22305881.9, filed Jun. 17, 2022, the contents of which are hereby incorporated by reference herein.

### BACKGROUND

Video coding systems may be used to compress digital video signals, for example, to reduce the storage and/or transmission bandwidth needed for such signals. Video coding systems may include, for example, wavelet-based systems, object-based systems, and/or block-based systems, such as a block-based hybrid video coding system. In extended reality (XR) applications, the mechanisms for providing control of degree of freedom boundaries may not be adequate.

### SUMMARY

Systems, methods, and instrumentalities are disclosed for degree-of-freedom (DoF) control in extended reality (XR) experiences. In examples, a device may determine a first elementary degree of freedom (DoF) boundary associated with a user. The first elementary DoF boundary may be determined based on at least one of prior-to-runtime information or runtime information. The device may determine a second elementary DoF boundary associated with the user based on at least the prior-to-runtime information or the runtime information. The device may determine a consolidated DoF boundary based on the first elementary DoF boundary and the second elementary DoF boundary. On a condition that the determination of the consolidated DoF boundary is successful, the device may determine to control a movement of the user based on the consolidated boundary.

On a condition that the determination of the consolidated DoF boundary is not successful, the device may modify the first elementary DoF boundary or the second elementary DoF boundary to obtain a modified DoF boundary. The device may determine a new consolidated DoF boundary based on the modified DoF boundary and the first elementary DoF boundary or the second elementary DoF boundary. The device may determine the modified DoF boundary by determining not to consider a volumetric asset of one or more of the first elementary DoF boundary or the second elementary DoF boundary. The device may determine the modified DoF boundary by modifying a space constraint associated with the first elementary DoF boundary or the second elementary DoF boundary. The device may modify the space constraint by prompting the user to modify a physical environment of the user.

On a condition that the determination of the consolidated DoF boundary is not successful, the device may modify a virtual item within an XR environment associated with the user. The device may determine a consolidated DoF boundary based on the first elementary DoF boundary and the second elementary DoF boundary by determining that a physical environment of the first elementary DoF boundary and a physical environment of the second elementary DoF boundary are different. Based on the difference, the device may determine to disallow the first elementary DoF boundary in the consolidated DoF boundary.

The device may determine a consolidated DoF boundary based on the first elementary DoF boundary and the second elementary DoF boundary by determining that a physical environment of the first elementary DoF boundary and a physical environment of the second elementary DoF boundary are different. Based on the difference, the device may determine the consolidated DoF boundary based on a common intersection of the first elementary DoF boundary and the second elementary DoF boundary.

Each feature disclosed anywhere herein is described, and may be implemented, separately/individually and in any combination with any other feature disclosed herein and/or with any feature(s) disclosed elsewhere that may be impliedly or expressly referenced herein or may otherwise fall within the scope of the subject matter disclosed herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram showing an example video encoder.

FIG. 3 is a diagram showing an example of a video decoder.

FIG. 4 is a diagram showing an example of a system in which various aspects and examples may be implemented.

FIG. 5 shows an example of a protagonist where a player controls a tracking camera behind the protagonist.

FIG. 6 shows an example of a runtime processing model for user DoF control.

FIG. 7 shows an example of a runtime processing model for user DoF control.

FIG. 8 shows DoF constraints associated with volumetric assets.

FIG. 9 shows an example boundary extension at content mesh node level.

FIG. 10 shows an example of boundary extension at a regular node level.

FIG. 11 shows an example of boundary extension at root node level.

FIG. 12 shows an example of boundary extension at mesh level.

FIG. 13 shows an example of computation of the consolidated DoF boundaries.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

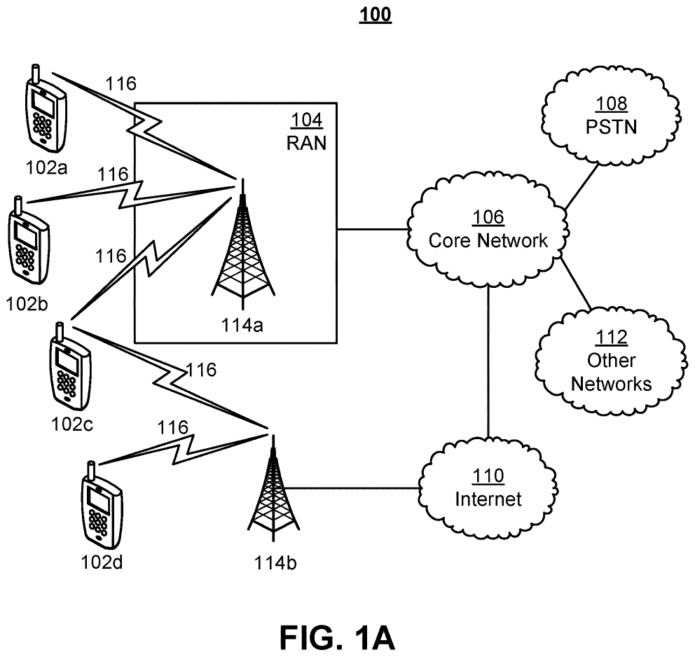

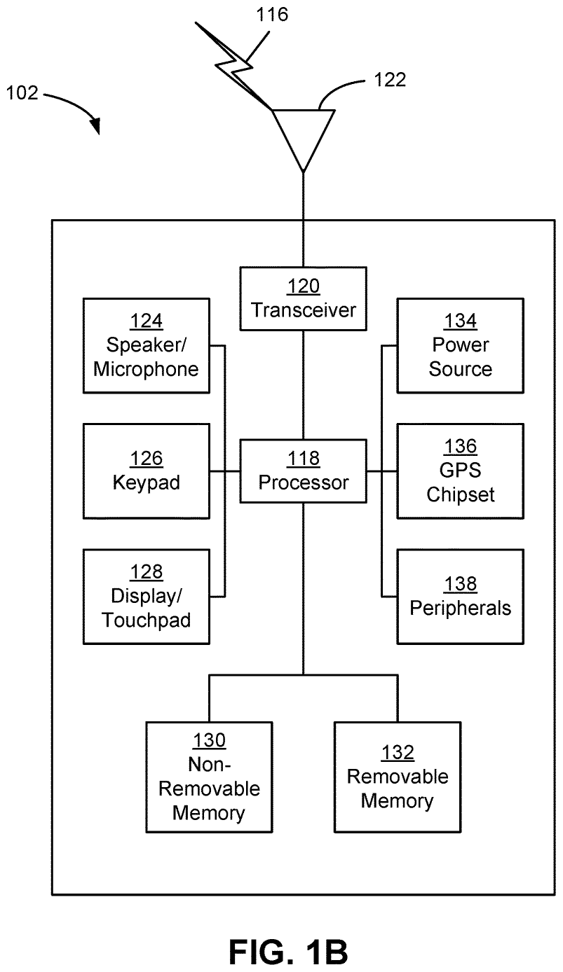

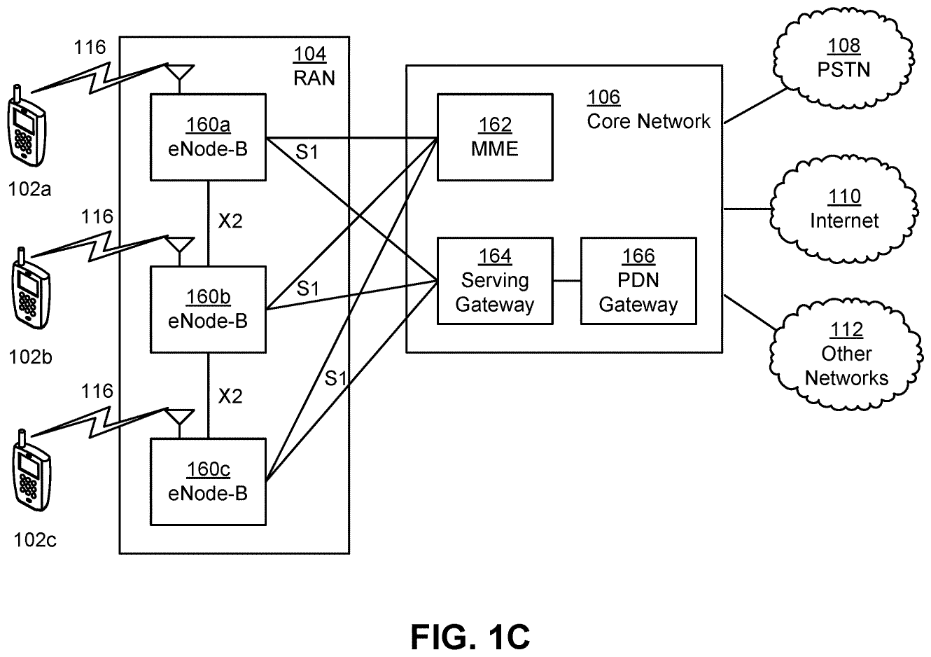

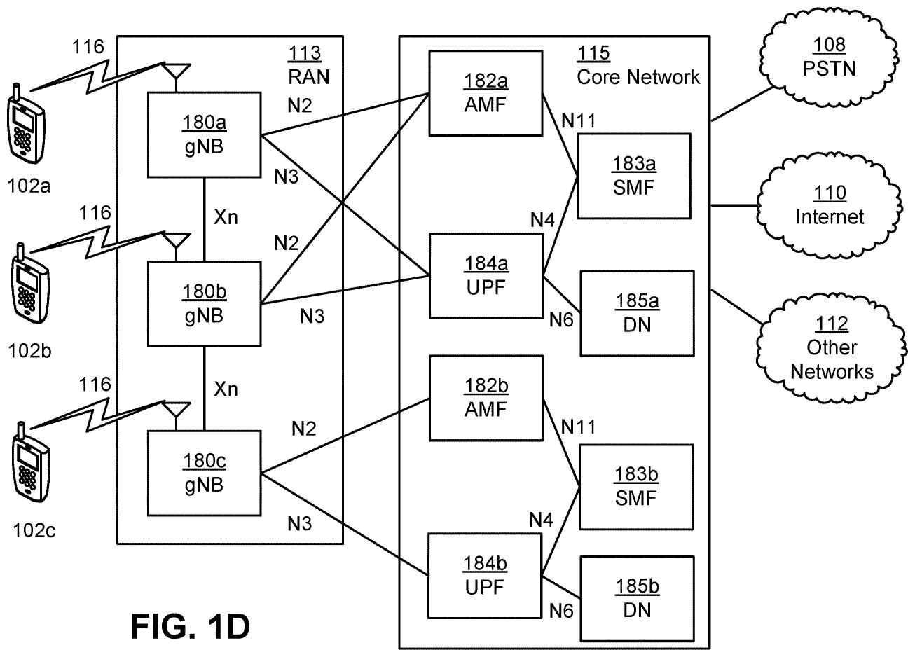

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b, and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples or embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

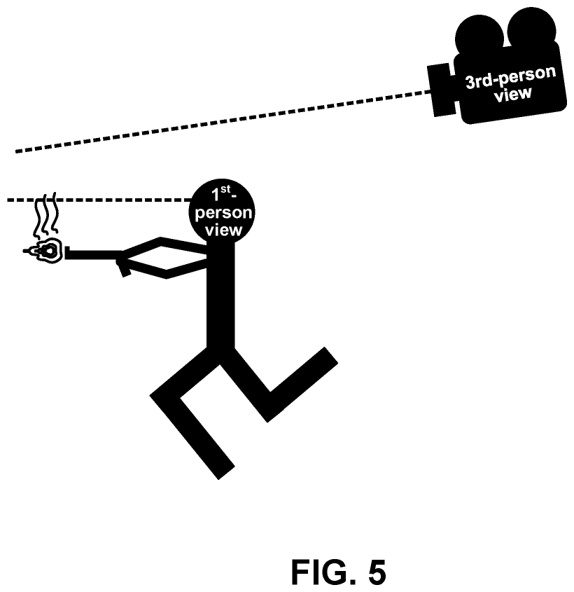

The aspects described and contemplated in this application may be implemented in many different forms. FIGS. 5-8 described herein may provide some embodiments, but other embodiments are contemplated. The discussion of FIGS. 5-8 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

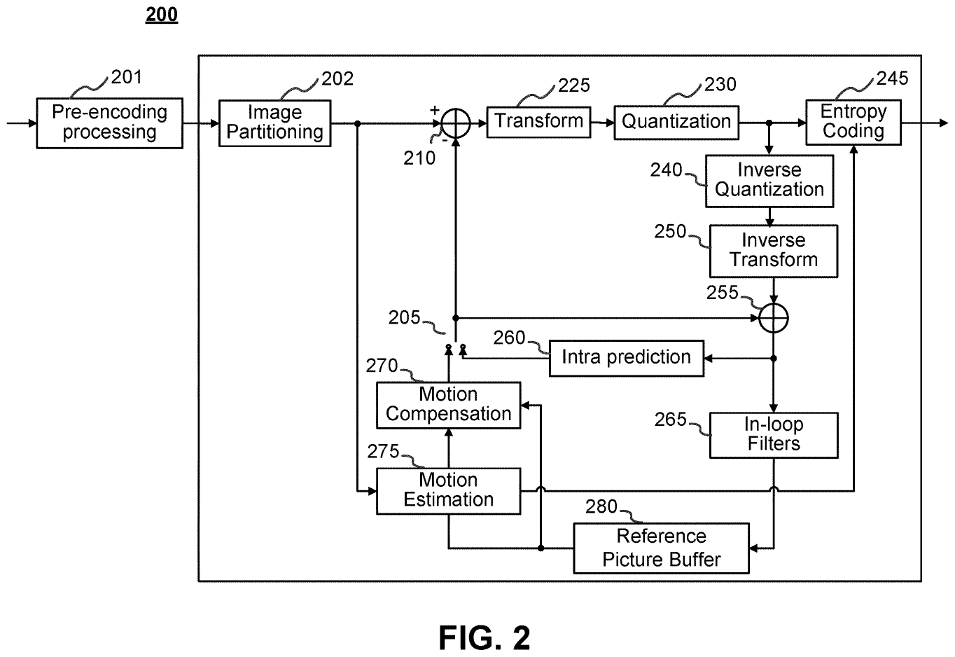

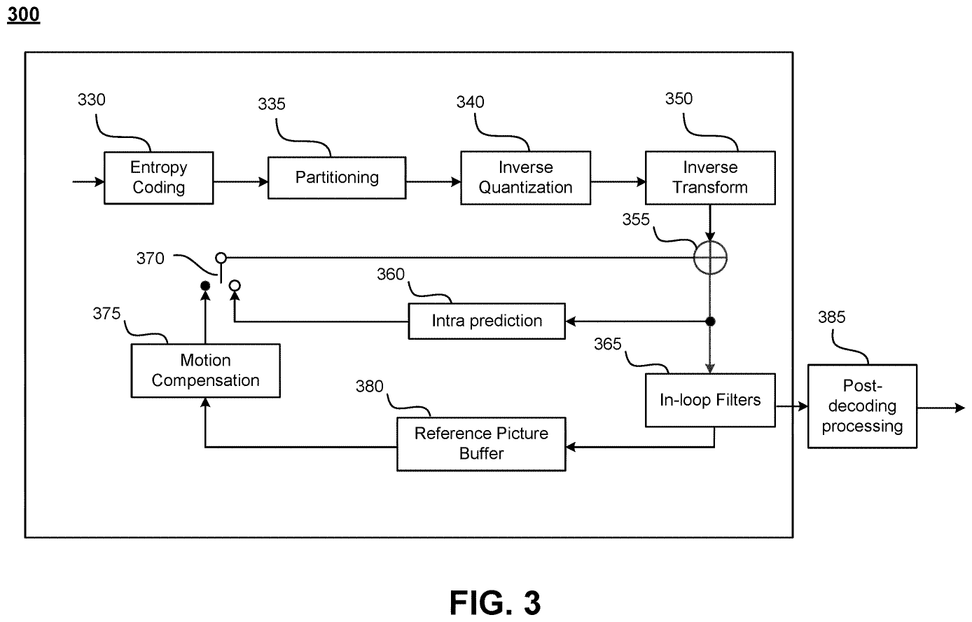

Various methods and other aspects described in this application may (for example, be used to) modify modules, for example, pre-encoding processing 201, intra prediction 260, entropy coding 245 and/or entropy decoding modules 330, intra prediction 360, post-decoding processing 385, of a video encoder 200 and a video decoder 300 as shown in FIG. 2 and FIG. 3 respectively. Moreover, the subject matter disclosed herein presents aspects that are not limited to WC or HEVC, and may be applied, for example, to any type, format or version of video coding, whether described in a standard or a recommendation, whether pre-existing or future-developed, and extensions of any such standards and recommendations (e.g., including VVC and HEVC). Unless indicated otherwise, or technically precluded, the aspects described in this application may be used individually or in combination.

Various numeric values are used in examples described the present application, such as minimum and maximum value ranges (for example, 0 to 1, 0 to N or 0 to 255), bit values for indications or determinations, default values, ID numbers (for example, for adaptation IDs), etc. These and other specific values are for purposes of describing examples and the aspects described are not limited to these specific values.

FIG. 2 is a diagram showing an example video encoder. Variations of example encoder 200 are contemplated, but the encoder 200 is described below for purposes of clarity without describing all expected variations.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing, and attached to the bitstream.

In the encoder 200, a picture is encoded by the encoder elements as described below. The picture to be encoded is partitioned (202) and processed in units of, for example, coding units (CUs). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

FIG. 3 is a diagram showing an example of a video decoder. In example decoder 300, a bitstream is decoded by the decoder elements as described below. Video decoder 300 generally performs a decoding pass reciprocal to the encoding pass as described in FIG. 2. The encoder 200 may also generally perform video decoding as part of encoding video data. For example, the encoder 200 may perform one or more of the video decoding steps presented herein. The encoder reconstructs the decoded images, for example, to maintain synchronization with the decoder with respect to one or more of the following: reference pictures, entropy coding contexts, and other decoder-relevant state variables.

In particular, the input of the decoder includes a video bitstream, which may be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block may be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

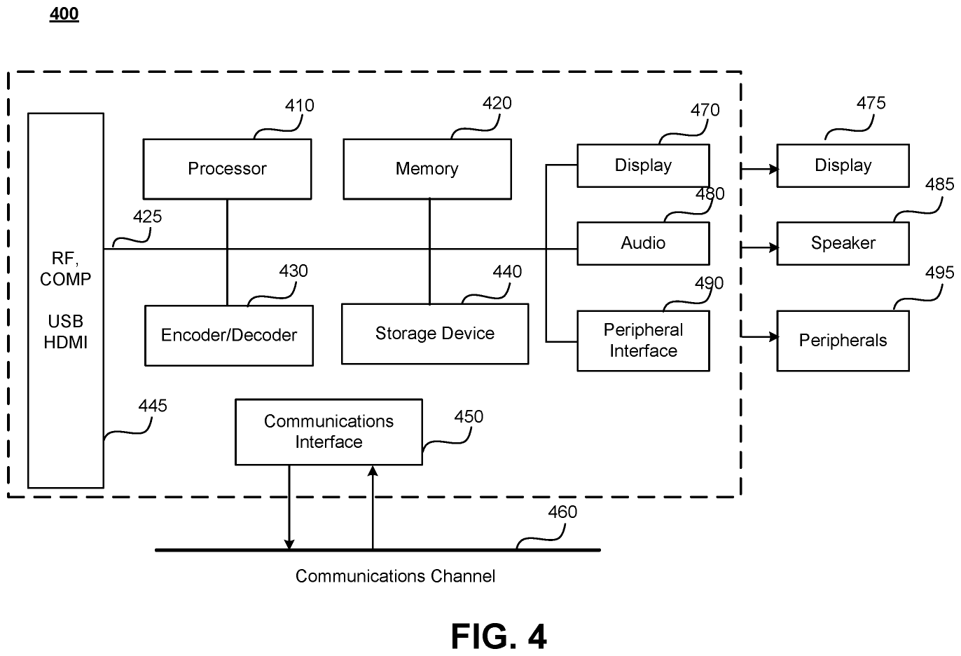

FIG. 4 is a diagram showing an example of a system in which various aspects and embodiments described herein may be implemented. System 400 may be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various embodiments, the system 400 is communicatively coupled to one or more other systems, or other electronic devices, via, for example, a communications bus or through dedicated input and/or output ports. In various embodiments, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that may be included in a device to perform the encoding and/or decoding functions. As is known, a device can include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various embodiments, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 410 and/or the encoder/decoder module 430 is used to store instructions and to provide working memory for processing that is needed during encoding or decoding. In other embodiments, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as, for example, MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various embodiments, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which may be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the data stream as necessary for presentation on an output device.

Various elements of system 400 may be provided within an integrated housing. Within the integrated housing, the various elements may be interconnected and transmit data therebetween using suitable connection arrangement 425, for example, an internal bus as known in the art, including the Inter-IC (I2C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 may be implemented, for example, within a wired and/or a wireless medium.

Data is streamed, or otherwise provided, to the system 400, in various embodiments, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these embodiments is typically connected to an access point or router that provides access to external networks including the Internet for allowing streaming applications and other over-the-top communications. Other embodiments provide streamed data to the system 400 using a set-top box that delivers the data over the HDMI connection of the input block 445. Still other embodiments provide streamed data to the system 400 using the RF connection of the input block 445. As indicated above, various embodiments provide data in a non-streaming manner. Additionally, various embodiments use wireless networks other than Wi-Fi, for example a cellular network or a Bluetooth network.

The system 400 can provide an output signal to various output devices, including a display 475, speakers 485, and other peripheral devices 495. The display 475 of various embodiments includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 can also be integrated with other components (for example, as in a smart phone), or separate (for example, an external monitor for a laptop). The other peripheral devices 495 include, in various examples of embodiments, one or more of a stand-alone digital video disc (or digital versatile disc) (DVR, for both terms), a disk player, a stereo system, and/or a lighting system. Various embodiments use one or more peripheral devices 495 that provide a function based on the output of the system 400. For example, a disk player performs the function of playing the output of the system 400.

In various embodiments, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various embodiments, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various embodiments in which the display 475 and speakers 485 are external components, the output signal may be provided via dedicated output connections, including, for example, HDMI ports, USB ports, or COMP outputs.

The embodiments may be carried out by computer software implemented by the processor 410 or by hardware, or by a combination of hardware and software. As a non-limiting example, the embodiments may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, determining a first elementary degree of freedom (DoF) boundary associated with a user, wherein the first elementary DoF boundary is determined based on prior-to-runtime information and runtime information; determining a second elementary DoF boundary associated with the user during the runtime; determining a consolidated DoF boundary based on the first elementary DoF boundary and the second elementary DoF boundary; and on a condition that the determination of the consolidated DoF boundary is successful, modifying an extended reality (XR) environment associated with the runtime based on the consolidated DoF boundary.

As further embodiments, in one example “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, determining a first elementary degree of freedom (DoF) boundary associated with a user, wherein the first elementary DoF boundary is determined based on prior-to-runtime information and runtime information; determining a second elementary DoF boundary associated with the user during the runtime; determining a consolidated DoF boundary based on the first elementary DoF boundary and the second elementary DoF boundary; and on a condition that the determination of the consolidated DoF boundary is successful, modifying an extended reality (XR) environment associated with the runtime based on the consolidated DoF boundary.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein, such as syntax elements that may be indicated in Tables 1-5 and otherwise indicated in discussion or figures presented herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

During the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment,” “an embodiment,” “an example,” “one implementation” or “an implementation,” as well as other variations thereof, means that a particular feature, structure, characteristic, and so forth described in connection with the embodiment is included in at least one embodiment. Thus, the appearances of the phrase “in one embodiment,” “in an embodiment,” “in an example,” “in one implementation,” or “in an implementation”, as well any other variations, appearing in various places throughout this application are not necessarily all referring to the same embodiment or example.

Additionally, this application may refer to “determining” various pieces of information. Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in some embodiments the encoder signals (e.g., to a decoder) an MPD, adaptation set, a representation, a preselection, G-PCC components, a G-PCCComponent descriptor, a G-PCC descriptor or an essential property descriptor, a supplemental property descriptor, a G-PCC tile inventory descriptor, G-PCC static spatial regions descriptor, GPCCTileld descriptor GPCC3DRegionID descriptor, among other descriptors, elements and attributes, metadata, schemas, etc. (for example, as disclosed herein, including in Tables 1-5), etc. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, signaling may be used without transmitting (implicit signaling) to simply allow the decoder to know and select the particular parameter. By avoiding transmission of any actual functions, a bit savings is realized in various embodiments. It is to be appreciated that signaling may be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

In extended reality (XR) applications, user movement may be defined as a degree-of-freedom (DoF), which may be affected (e.g., restricted) by one or more of the following constraints: the allowed capabilities of the users in an XR experience; the viewing limitations of XR assets (e.g., volumetric video streams or other media assets which have limited views due to inherit capturing configuration); the type of the XR experience associated with dedicated user movements; the performance of the implemented spatial tracking to provide an accurate user pose estimation at runtime; and/or the available space in which the user may move freely and safely. The allowed capabilities of the user(s) in an XR experience may include the 6 DoF capabilities and/or 3 DoF capabilities. An XR game may include modes, such as a player mode and a spectator mode. Two or more participants may join to play the XR game in player mode. A spectator may join to watch the XR game in spectator mode. Participants with player mode may have the DoF capabilities (e.g., 6 DoF capabilities) to move freely within a room. Participants in spectator mode may have modified DoF capabilities (e.g., 3 capabilities) to watch the participants that are in player mode play. The viewing of one or more XR assets, such as volumetric video streams (e.g., MPEG point cloud compression (PCC), MPEG immersive video (MIV), etc.) or other media assets may have limited views due to inherit capturing configuration. The type of the XR experience, e.g., requiring dedicated user movements, may include, for example, an XR racing simulator which may use a seated user, an XR dance game which may use a room-scale user movement, and/or a museum visit XR experience which may use world-scale user movements. The performance of the spatial tracking to provide an accurate user pose estimation at runtime may include different types of tracking that exist, such as outside-in, inside-out, world tracking, simultaneous localization, and/or mapping (SLAM), etc. The available space may be the space in which the user may move freely and safely, which may be related to full-immersive virtual reality (VR) experiences, where the user cannot see their real (e.g., their physical) surrounding environment.

The constraints described herein may be static. For example, a set of constraints may not change during the XR experience. The viewing (e.g., viewing limitation) from the volumetric assets and the spatial tracking performance may be known before application runtime. The constraints may be timed. For example, a set of constraints may be expected to be applied at a given time instance during the playback of the XR experience. The timing of the playback of the timed constraints may be encapsulated by a means other than a scene description. The capabilities of a user representation may evolve based on the elapsed time of an XR experience. The user representation (e.g., avatar/camera) may follow a pre-defined path within the virtual world. The constraints may be non-timed. For example, a set of constraints may be applied (e.g., be expected to be applied) at occurrence of an event during the XR experience playback. The triggering of the constraints may be encapsulated by a means other than a scene description. The available space may be modified at runtime due to a change (e.g., any change) in the real environment of the user (e.g., accurate estimation of the available space, displacement of a real object, etc.) The capabilities of a user may evolve based on user actions at runtime (e.g., gain of experience, finding a specific virtual item, etc.). The events may be pre-defined within an XR interactivity framework which includes a combination of triggers and actions.

The constraints may define different limited scopes for the DoF of users experiencing different use cases. A framework may be used to define and control multiple DoF boundaries, for example, when multiple users share a common XR experience (e.g., consistently).

A player in an XR experience may observe the XR experience in different examples. In examples, the XR experience may be observed through the eyes of the protagonist, such as first-person shooter games. In examples, the protagonist may be viewed on-screen during play such as in third-person shooter games. User experience mode in the first form may be referred to as viewer herein and user experience mode in the second form may be referred to as “viewer+avatar” herein, where an avatar is the model of the protagonist playing the game (e.g., as shown in FIG. 5).

DoF constraints may be applicable to a case (e.g., individual case) and/or multiple cases (e.g., multiple cases combined). In the case where both forms of user experience modes are considered, the term user representation may be used. In examples, a user (e.g., represented via an avatar or a camera in the 3D scene) may have the capability to fly and another user may have the capability to crawl.

FIG. 5 shows an example of a protagonist where a player controls a tracking camera located just behind the protagonist. A DoF constraint may include a DoF boundary. A DoF boundary may be expressed through a bounded volume. Inside the bounded volume, the DoF constraints may be applicable.

A framework may be used to control the DoF boundaries for user(s) sharing an XR experience. The framework may include one or more of the following: determination of the elementary boundaries from the DoF constraints for a user; computation of the consolidated DoF boundaries for a user; or control of the user movements with respect to the consolidated DoF boundaries (e.g., one or multiple pre-defined action(s) may be launched if the user reaches the allowed boundaries or if the computation results in no possible consolidated DoF boundaries).

The XR scene description semantic(s) may be augmented to provide the pre-defined data, e.g., associated with the framework. For example, at the scene level, pre-defined data may be common to users (e.g., all users) to avoid data duplication as, for example, data related to spatial tracking performance if the users (e.g., all users) have the same type of XR device and/or data related to available space if the users (e.g., all users) share the same real environment. For a user representation (e.g., a user representation which may involve an avatar/camera) in the scene description, pre-defined data specific to a user in addition to the conventional user representation data in the XR experience (e.g., viewing frustrum, avatar size, mesh collider) may be included as data related to the user movement capabilities.

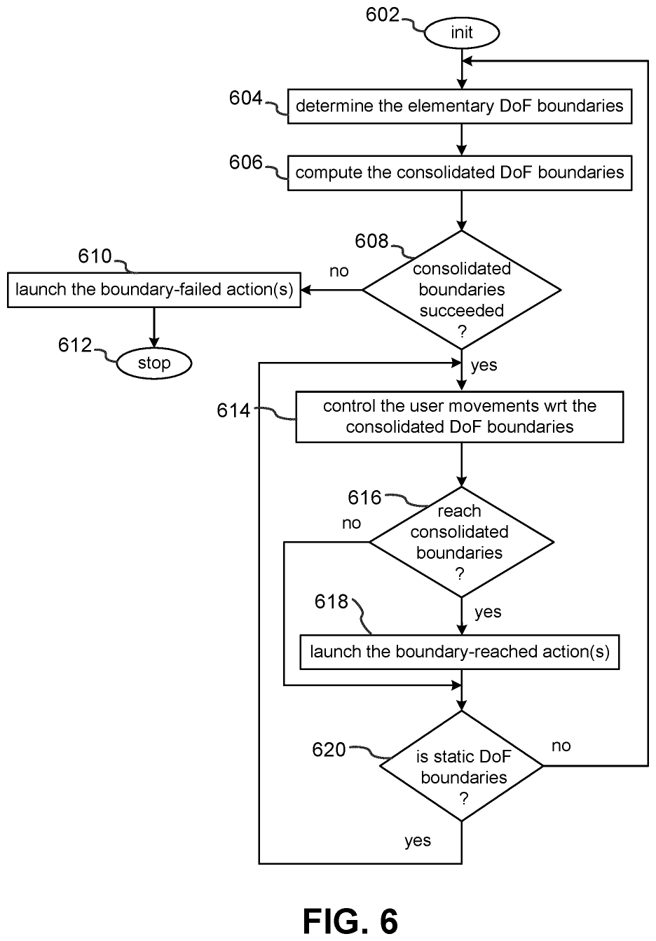

A scene description framework using a Khonos gITF extension mechanism may be utilized in association with one or more features described herein. A runtime processing model, as shown in FIG. 6, may be shown for a user sharing the XR experience.

FIG. 6 illustrates an example block of a technique for managing DoF boundaries within an XR environment. At 602, an initialization phase may take place. The initialization phase may establish parameters and data structures that are associated with executing the technique. At 604, elementary DoF boundaries may be determined. For example, analyses of data inputs from sources like user settings, sensor data, or system configurations may be performed. At 606, consolidated DoF boundaries may be computed. The consolidated DoF boundaries may be computed based on a subset of the elementary boundaries, e.g., integration into a comprehensive boundary. One or more consolidated DoF boundaries may be utilized to guide a user's movement within an XR environment.

At 608, a check may be conducted to determine if the computation of the consolidated boundaries was successful. If the computation of the consolidated boundaries was not successful, as indicated by the pathway labeled “no” leading to 610, boundary-failed actions may be launched. The computation of consolidated boundaries may not be successful, which may occur if no common intersection volume between elementary boundaries is found; boundary failed actions may be launched.

The boundary failed actions, which may start at 610, may include displaying an error message before terminating the application at 612. Users may have their own boundary-failed actions, referenced in their representation (e.g., avatar/camera) gITF extension via a boundaryFailedActions parameter. The boundaryFailedActions parameter, which may include a set of numbers corresponding to the actions defined in the interactivity framework, may look like “boundaryFailedActions.”

At 610, in the case of boundary-failed actions, the technique may stop at 612. If the computation of the consolidated boundaries was successful at 608, as indicated by the pathway labeled “yes” leading to 614, user movements within the XR environment may be controlled relative to the consolidated DoF boundaries. At 616, a computation may occur to assess if the user has reached the consolidated boundaries. If the user has reached the boundaries, as signified by the pathway labeled “yes” leading to 618, boundary-reached actions may be initiated.

At 618, once the boundary-reached actions have been launched, or if the user hasn't reached the consolidated boundaries at 616, it may be determined at 620 whether the DoF boundaries are static. At 620, if the boundaries are static, signified by the pathway labeled “yes” leading back to 614, the control of user movements within the XR environment based on the consolidated DoF boundaries may be maintained. If the boundaries are not static, as indicated by the pathway labeled “no” leading back to 604, the process of determining the elementary Degrees of Freedom boundaries may begin anew.

FIG. 6 shows an example of a runtime processing model for user DoF control. #The processing model may include one or more of the following: determination of the elementary DoF boundaries; computation of the consolidated DoF boundaries; and/or control of the user movements with respect to the consolidated DoF boundaries. #

Determination of the elementary DoF boundaries may be provided. For a user, the DoF constraints leading to the determination of elementary DoF boundaries may be based on a set of inputs. There may be multiple (e.g., two) kinds of DoF constraints, which may include one or more of the following. The constraints may include DoF constraints defined prior to runtime of the application which may be calculated by a pre-processing technique. The application may be provided with the information on DoF constraints for the user to experience the XR scene. For example, the precomputed DoF constraints may be used such that the user representation may move freely and safely. The DoF constraints may have been computed based on a scanned representation of the user environment (e.g., or based on other means). The precomputed DoF constraint may be a restricted viewing space associated with a 3D object for a user representation. The constraints may include DoF constraints defined at runtime by the application. The application may rely on XR frameworks such as OpenXR to determine the DoF constraints.

DoF constraints defined prior to runtime may be provided. The pre-defined data for the constrained DoF may be provided in the XR scene description file. The XR scene description file may be the entry point for the user's application to run and render the XR experience. To provide the data on constrained DoFs, the XR scene description file may be augmented by adding gITF extension(s).

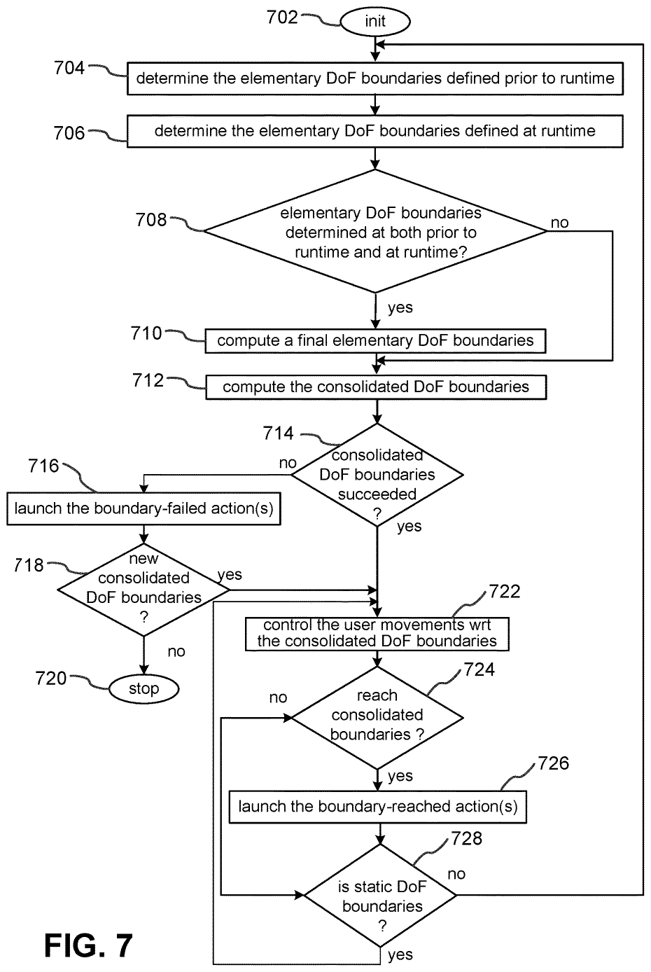

FIG. 7 illustrates an example block diagram of a technique for managing DoF boundaries within an XR environment. At 702, there may be an initialization process. The initialization process may set up system parameters and data structures for the technique. At 704, elementary DoF boundaries defined prior to runtime may be determined. These boundaries may be based on pre-set configurations, system settings, or user preferences. At 706, elementary DoF boundaries defined at runtime may be determined. The elementary DoF boundaries defined at runtime may involve using real-time inputs, such as sensor data or user interactions.

At 708, it may be determined whether elementary DoF boundaries were determined both prior to runtime and at runtime. If elementary DoF boundaries were determined both prior to runtime and at runtime, as indicated by the pathway labeled “yes” leading to 710, a final elementary DoF boundary may be computed. At 712, the consolidated DoF boundaries may be computed based on the elementary boundaries and the final elementary DoF boundary. At 714, a check may be conducted to assess if the computation of the consolidated boundaries was successful. If not, as indicated by the pathway labeled “no” leading to 716, boundary-failed actions may be launched. The boundary failed actions, which may start at 716, may include displaying an error message or modifying elementary DoF boundaries to create a valid consolidated boundary. These modifications may include user instructions to modify their surroundings, adjustments to the pose or certain volumetric assets, and/or altering the DoF constraints linked to user representation capabilities (e.g., removing a portion from an XR scene correlating to a user's physical surroundings).

At 718, a determination may be made whether new consolidated DoF boundaries may be computed. If the consolidated DoF boundaries are not computed (e.g., are unable to be computed, or are unable to be computed accurately), as indicated by the pathway labeled “no” leading to 720, the process may stop. At 720, if computation of new consolidated DoF boundaries was not successful, the process may terminate and an error messages may be displayed. If computation of new consolidated boundaries was successful, as indicated by the pathway labeled “yes” leading to 722, user movements within the XR environment may be controlled relative to the consolidated DoF boundaries. Interaction (e.g., interaction in addition to interaction allowed before the computation of the new consolidated DoF boundaries) within the XR environment may be allowed, as the new consolidated DoF boundaries may provide a larger space for user interaction. The computation of the new consolidated DoF boundaries may enable a rendering (e.g., a finer rendering), as an accurate (e.g., more accurate) understanding of the usable physical space may have been made. The computation of the new consolidated DoF boundaries may enable safety features, such as alerts or visual indications when the user is approaching a consolidated DoF boundary.

At 722, following control of user movements, an assessment may be made at 724, an evaluation may be made whether a user has reached the consolidated boundaries. At 724, if the user has reached the consolidated boundaries, as indicated by the pathway labeled “yes” leading to 726, boundary-reached actions may be initiated.

At 726, once the boundary-reached actions have been initiated, or if the user hasn't reached the consolidated boundaries at 724, it may be determined at 728 whether the DoF boundaries are static. At 728, if the boundaries are static, as indicated by the pathway labeled “yes” leading back to 722, the control of user movements based on the consolidated DoF boundaries may continue. If the boundaries are not static, as indicated by the pathway labeled “no” leading back to 704, the determination of the elementary Degrees of Freedom boundaries defined prior to runtime may start again.

For the DoF constraints based on the volumetric assets, there may be a volumetric asset which is a partial representation of volumetric scene or a volumetric 3D object. If the volumetric asset cannot be consumed in an unbounded space by a viewer, the volumetric asset may provide a parameter on a restricted viewing space in which the user may have a viewing experience (e.g., best viewing experience) of the volumetric asset.

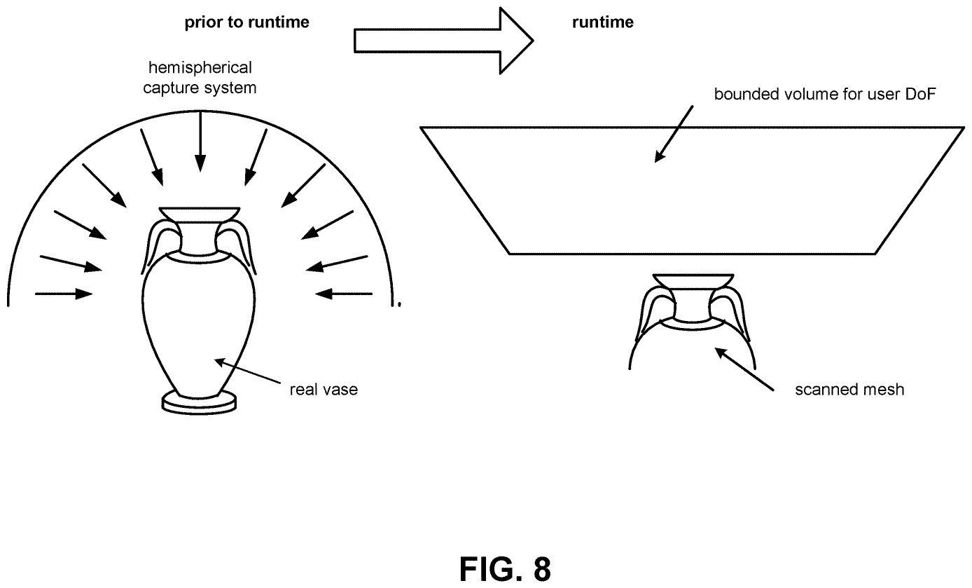

In examples, if a 3D object is partially captured, it may be the intention of the 3D object author to disallow the user to view the 3D object surfaces where the capturing was not performed. Disallowing the user to view the 3D object may lead to a restricted user movement in a bounded volume as there may exist no corresponding data for the 3D object from views outside of the bounded volume. A potential bounded volume may be shown in FIG. 8.

FIG. 8 shows an example of DoF constraints coming from volumetric assets. #The DoF constraints may be expressed as extensions to the node. The node may refer to the camera of the scene representing the “viewer” mode or an extension to the node which refers to the protagonist of the scene representing the “viewer+avatar” mode. In examples, the DoF constraints may be provided to the XR application by adding a gITF extension at the mesh level where the 3D object is expressed. #

There may be multiple techniques of providing DoF constraints. For example, the coordinates for the DoF boundaries may be provided through one or more of the following. The coordinates may be provided through a mesh object in a gITF file. The mesh object may represent the bounded volume geometry. The data for the bounded volume geometry may be embedded with the 3D object itself or may be through an external means. The coordinates may be provided through parameters expressing the bounded volume. There may be types of bounded volumes, such as cuboid, sphere, etc. For a cuboid, the parameters may include vertices position. For a sphere, the parameters may include a radius of the bounded sphere. The parameters may affect the user's movement and confine the user(s) to a viewing space enclosed inside the DoF boundaries.

The orientation of the user may be restricted within the bounded volume. In examples, minimum and maximum rotation angles may be provided. Rotation in a gITF file may be expressed through quaternions.

In examples, when the bounded volume is attached to a viewer node or an avatar node, the bounded volume and DoF constraints may be expressed in a world coordinate space of the XR scene.

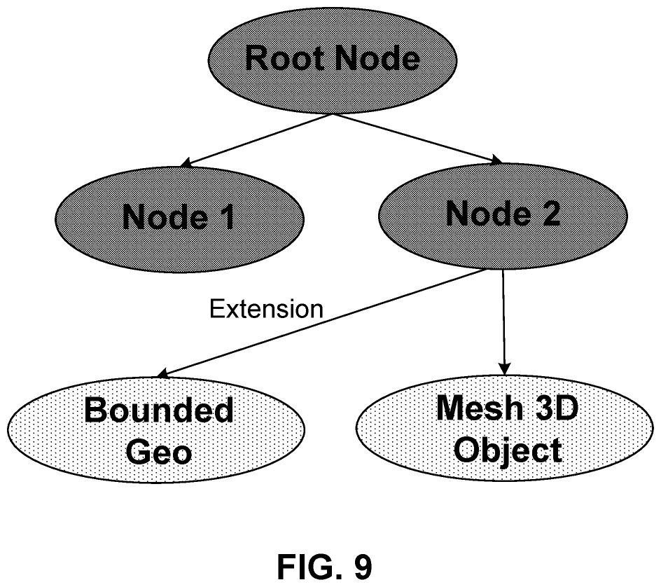

FIG. 9 shows an example boundary extension at a content mesh node level. In examples, when the bounded volume is attached as an extension to a regular node, the regular node may refer to the mesh 3D object as shown in FIG. 9. The coordinate space for the bounded geometry may be the same as that of the mesh 3D object. There may be an implicit offset between the 3D object geometry and bounded volume geometry. The bounded volume and DoF constraints may be expressed in a local coordinate space of the attached node (e.g., node 2 in FIG. 9). The DoF constraints may be applicable for the children of the regular node.

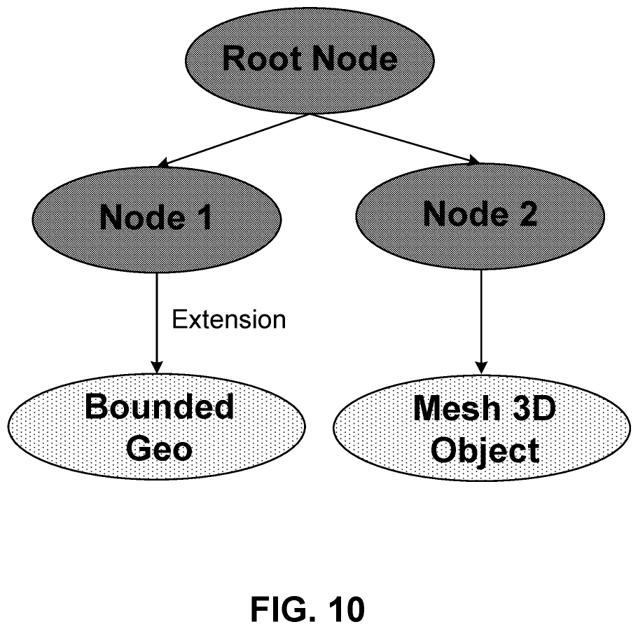

FIG. 10 shows an example of boundary extension at a regular node level. In examples, if the bounded volume is attached as an extension to a regular node in the node hierarchy, another regular node (e.g., node 2 in FIG. 10) may refer to the mesh 3D object, as shown in FIG. 10. The coordinate space for the bounded geometry may be different than that of the mesh 3D object since both geometries may obey the coordinate space of their inherited nodes. The bounded volume and DoF constraints may be provided in local coordinate space of an attached node (e.g., node 1 in FIG. 10). The DoF constraints may be applicable for the children of the regular node. #

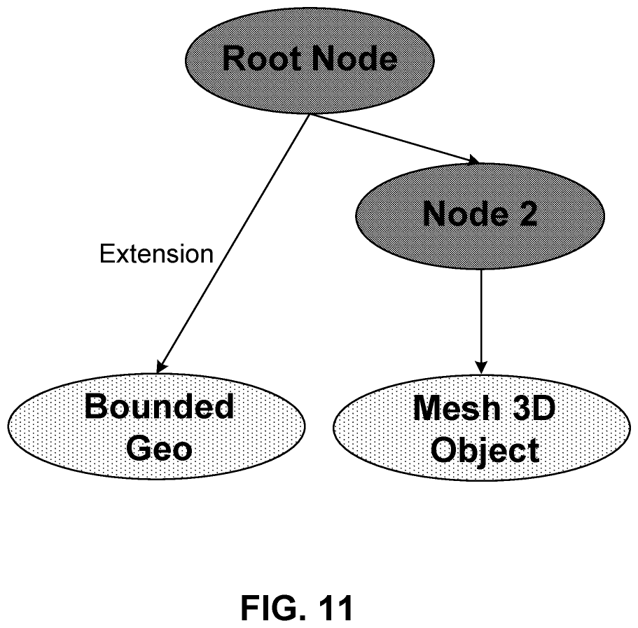

FIG. 11 shows an example of boundary extension at a root node level. In examples, when the bounded volume is attached as an extension to a root node, a regular node (e.g., node 2 in FIG. 11) may refer to the mesh 3D object, as shown in FIG. 11. The coordinate space for the bounded geometry may be the same as that of the root node. The bounded volume and DoF constraints may be provided in a local coordinate space of an attached node (e.g., root node in FIG. 11).

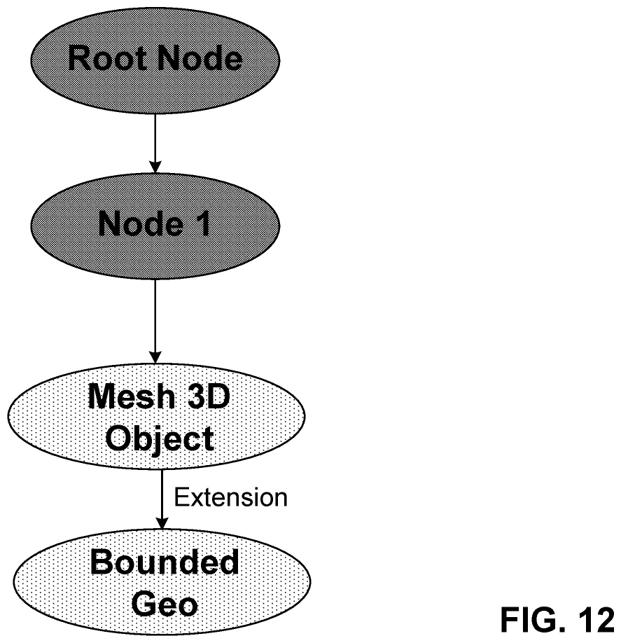

FIG. 12 shows an example of a boundary extension at mesh level. In examples, if the bounded is attached as an extension to a mesh as shown in FIG. 12, the coordinate space for the bounded geometry may be the same as that of the mesh 3D object. There may be an implicit offset between the 3D object geometry and bounded volume geometry. The bounded volume and DoF constraints may be provided in a local coordinate space of an attached node (e.g., node 1 in FIG. 12).

In examples, the DoF constraint data may be embedded in the volumetric asset format. The XR application may retrieve the DoF constraint after a decoding step. For example, the immersive video (e.g., MIV) may define the viewing space metadata corresponding to the viewing domain constraints. The XR application may calculate the related DoF boundaries based on the provided metadata. The data for the DoF boundaries may be supplied as a patch update to the scene description file. The patch update may update the scene description to generate a syntax as described herein.

Content may have DoF characteristics. The content may employ different DoF constraints than that of the main scene. In examples, a viewer may be free to perform 6 DoF movements within a viewing space. In examples, a binocular may be positioned in the scene. The viewer may want to look out from the binoculars. To simulate the viewing conditions from binoculars for the viewers, a 360-degree video may be displayed. The viewer may interact with the scene and select to observe the view from the binoculars. Upon selection, the DoF of the viewer is changed to the content specific DoF, e.g., 3 DoF in the case of 360-degree video. The rotations of the viewer's head movement are recorded and registered by the application. The rotations of the viewer's head movement correspond to the rotations for which the frames will be rendered. The content may explicitly specify the range of rotation for which the content rendering is possible. A viewer intending to rotate further than the range may trigger an interaction, thus leading an action. The relationship between action and interaction may be specified in extensions.

The user may move in his/her physical environment. The translation movements may be recorded. The translation movements in the case of 360-degree video may not have an impact to the rendering, as the content may support 3 DoF. The recorded translated movement of the user may be monitored by the XR runtime to determine that the user is within the confines of the restricted viewing space as communicated by the main scene. If the user translates out of the viewing space, the translation may be recorded as an interaction. The appropriate action to the interaction may be specified in extensions.

When the viewer intends to exit from the binoculars experience, the scene DoF constraint may take over. The user may be positioned back in the scene from where the user entered the binoculars experience. The pose movements of the viewer may be recorded and registered to render the correct rendering of the frame of the scene. The frame rendering may be governed by the translation and rotation properties of the user.

The content may correspond to 6 DoF constraints. The properties of the 6 DoF constraints of the content may be different than that of the parent 6 DoF properties of the scene or a scene object in the hierarchy described herein. The DoF constraints of the element in the leaf node may take precedence.

Table 1 may represent the semantics of an extension which expresses the DoF constraints containing information related to DoF boundaries.

TABLE 1
MPEG_mesh/node_boundary_extension

| Name | Type | Default | Usage | Description |
|---|---|---|---|---|
| boundaryType | Number | 1 | 0 | Describes the boundaries type to be |
| | | | | used for the viewing space. |
| | | | | 0 = glTF mesh |
| | | | | 1 = Bounded volume |
| boundaryMesh | Number | — | O | Index in the mesh array vertex |
| | | | | positions boundaries are used for |
| | | | | defining the boundaries when |
| | | | | “boundaryType” is set to 0 |
| volumeType | Number | — | O | Describes the bounded volume type |
| | | | | in case “boundaryType” is of type |
| | | | | “bounded volume” |
| | | | | 0 = Cuboid |
| | | | | 1 = Sphere |
| volumeVertices | Array | — | O | Describes the vertices position for a |
| | | | | bounded volume type of Cuboid |
| volumeRadius | Number | — | O | Describes the radius for a bounded |
| | | | | volume type of Sphere |
| rotationMin | Array | — | O | Minimum rotation values allowed in |
| | | | | the boundary |
| rotationMax | Array | [ ] | O | Maximum rotation values allowed in |
| | | | | the boundary |
| translationMin | Array | — | O | Minimum translation values allowed |
| | | | | in the boundary |
| translationMax | Array | — | O | Maximum translation values allowed |
| | | | | in the boundary |

```
“MPEG_DoF_constraints_from_volumetric_asset” : {
  “boundaryType” : #boundaryType,
if (“boundaryType” == 0 ) {
  “boundaryMesh”: #meshIndex
},
else if (“boundaryType” == 1) {
  “volumeType” : #type_of_boundary_volume,
  if(“volumeType” == 0) {
    “volumeVertices”: [ #Array_of_vertices]
  } else if ( “volumeType” == 1) {
    “volumeRadius” : #radius
  }
}
“rotationMin”: [ minW, minX, minY, minZ ] ,
“rotationMax”: [ maxW, maxX, maxY, maxZ ],
“translationMin”: [ minX, minY, minZ ],
“translationMax”: [ maxX, maxY, maxZ ]
}
```

For the DoF constraints derived from the XR application type and/or the performance of the user tracking system, the type of the XR application and/or the performance of the user tracking system may affect the user movements to allow accurate pose estimation.

Multiple user-constraint spaces, which may be referred to as XR reference spaces, may be provided. In examples, the multiple user-constraint spaces may be provided, for example, using the OpenXR framework and/or the WebXR framework. In examples, the characteristics of the WebXR reference spaces may include one or more of the following. A local reference space may correspond to seated XR experiences (e.g., immersive 2D video viewer, racing simulator, and/or solar system explorer) which may not involve the user moving around in space. It may correspond to 3DoF/3DoF+ user constraints related to the user head movements. A bounded reference space may correspond to room-scale XR experiences (e.g., XR dance games, VR painting/sculpting, etc.) in which the user moves around its physical environment beyond fixed boundaries to interact (e.g., fully interact) with the virtual content. The bounded reference space may correspond to a constrained 6 DoF. The boundaries may be fixed and pre-established depending on the space (e.g., space requirement) of the XR experience. An unbounded reference space may correspond to world-scale XR experiences (e.g., museum visit, city tour, etc.) in which the user moves freely around its physical environment and travels distances. The unbounded reference space may correspond to a 6 DoF with no (e.g., or infinite) boundaries. A geospatial tracking system may be used for outdoor XR experiences. A view reference space may correspond to XR experiences (e.g., a head-up display of information, furniture viewer using click-and-drag controls to look around, etc.), where the XR content may stay at a fixed point giving the appearance of having no tracking. The origin of the reference space may be (e.g., may always be) at the pose of the viewer device. The user DoF constraints may depend on the performance of the user tracking system.

A DoF constraint may be provided to the XR application by adding a gITF extension, e.g., either at the scene level if the users (e.g., all the users) have the same type of reference space, or at the user representation (e.g., avatar/camera) level for dedicated user reference space. The type of the reference space between the local, bounded and unbounded view types may be provided using an enumerator or an explicit text.

For the local and bounded reference spaces, a boundaries parameter may be defined. DoF constraints may be provided in one or more of the following examples. The coordinates for the DoF boundaries may be provided through a mesh object in a gITF file. The mesh object may represent the bounded volume geometry. The coordinates may be provided through parameters expressing the bounded volume. There may be types of bounded volumes such as a cuboid, sphere, etc. For a cuboid, the parameters may be the vertices global position. For a sphere, the parameters may be the radius of the bounded sphere.

Table 2 illustrates an example of providing data in an XR application world space.

TABLE 2
Providing data in an XR application world space.

| Name | Type | Default | Usage | Description |
|---|---|---|---|---|
| referenceSpaceType | Number | 0 | M | Describes the reference space type to |
| | | | | be used by the XR application. |
| | | | | 0 = Local |
| | | | | 1 = Bounded |
| | | | | 2 = Unbounded |
| | | | | 3 = View |
| boundaryType | Number | 1 | M | Describes the boundaries type to be |
| | | | | used for the viewing space. |
| | | | | 0 = glTF mesh |
| | | | | 1 = Bounded volume |
| boundaryMesh | Number | — | O | Index in the mesh array vertex positions |
| | | | | boundaries are used for defining the |
| | | | | boundaries when “boundaryType” is set |
| | | | | to 0 |
| volumeType | Number | — | O | Describes the bounded volume type in |
| | | | | case “boundaryType” is of type |
| | | | | “bounded volume” |
| | | | | 0 = Cuboid |
| | | | | 1 = Sphere |
| volumeVertices | Array | — | O | Describes the vertices position for a |
| | | | | bounded volume type of Cuboid |
| volumeRadius | Number | — | O | Describes the radius for a bounded |
| | | | | volume type of Sphere |

```
“MPEG_DoF_constraints_from_application_type” : {
“referenceSpaceType” : #referenceSpaceType,
if ((“referenceSpaceType” == 0 ) ∥ (“referenceSpaceType” == 1 )) {
“boundaryType” : #boundaryType,
if (“boundaryType” == 0 ) {
  “boundaryMesh”: #meshIndex
},
else if (“boundaryType” == 1) {
  “volumeType” : #type_of_boundary_volume,
  if(“volumeType” == 0) {
    “volumeVertices”: [ #Array_of_vertices]
  } else if ( “volumeType” == 1) {
    “volumeRadius” : #radius
  }
}
}
}
```

The DoF constraints may be related to the available space. The available space in which the user may move freely and safely may be known prior to runtime based on the analysis of a scanned representation of the real environment. For example, the largest area of the floor being free of an obstacle (e.g., any obstacle) may be determined during a prior computation by performing one or more of the following: by iterating on the scanned mesh vertices and by identifying the vertices having the same height (e.g., the same lowest y coordinates); by calculating the contours enclosing the different floor area candidates; or by taking the largest area between the area candidates (e.g., all the area candidates).

The resulting area may be delimited by a polygon contour comprised of connected vertices. The height of the ceiling or a hanging obstacle (e.g., any hanging obstacle) over that resulting largest area may be determined to identify an available 3D space. The available space boundaries may be provided in the scene description file.

An available space constraint may be provided to the XR application by adding a gITF extension, e.g., at the scene level if the users share the same real environment, or at the user representation (e.g., avatar/camera) level for a dedicated user's real environment. There may be multiple ways of expressing the DoF constraints. For example, the coordinates for the DoF boundaries may be provided through a mesh object in a gITF file. The mesh object may represent the bounded volume geometry. The coordinates may be provided through parameters expressing the bounded volume. There may be different types of bounded volumes, such as a cuboid, sphere, etc. For a cuboid, the parameters may be the vertices global position. For a sphere, the parameters may be the radius of the bounded sphere.

Table 3 illustrates an example of providing data in the XR application world space.

TABLE 3
Providing data in the XR application world space

| Name | Type | Default | Usage | Description |
|---|---|---|---|---|
| boundaryType | Number | 1 | M | Describes the boundaries type to be |
| | | | | used for the viewing space. |
| | | | | 0 = glTF mesh |
| | | | | 1 = Bounded volume |
| boundaryMesh | Number | — | O | Index in the mesh array vertex positions |
| | | | | boundaries are used for defining the |
| | | | | boundaries when “boundaryType” is set |
| | | | | to 0 |
| volumeType | Number | — | O | Describes the bounded volume type in |
| | | | | case “boundaryType” is of type |
| | | | | “bounded volume” |
| | | | | 0 = Cuboid |
| | | | | 1 = Sphere |
| volumeVertices | Array | — | O | Describes the vertices position for a |
| | | | | bounded volume type of Cuboid |
| volumeRadius | Number | — | O | Describes the radius for a bounded |
| | | | | volume type of Sphere |

```
“MPEG_DoF_constraints_from_available_space” : {
“boundaryType” : #boundaryType,
if (“boundaryType” == 0 ) {
  “boundaryMesh”: #meshIndex
},
else if (“boundaryType” == 1) {
  “volumeType” : #type_of_boundary_volume,
  if(“volumeType” == 0) {
    “volumeVertices”: [ #Array_of_vertices]
  } else if ( “volumeType” == 1) {
    “volumeRadius” : #radius
  }
}
}
```

For the DoF constraints related to the user representation capabilities in the XR experience, a user representation may not have the same DoF in a XR experience. In examples, a user representation may be allowed to walk around (e.g., everywhere) in the virtual world. A user representation may be allowed to walk around a single room. A user representation may fly, and a user representation may crawl, etc.

The constraints may be one or more of the following. The constraints may be static (e.g., as they do not change during the XR experience). The constraints may be timed (e.g., as expected to be applied at a given time instance during the playback of the XR experience). The capabilities of a user representation may evolve based on the elapsed time of an XR experience. The user representation may follow a pre-defined path within the virtual world. The constraints may be non-timed constraints which are expected to be applied at occurrence of an event during the XR experience playback. The capabilities of a user may evolve based on user actions at runtime (e.g., gain of experience, finding a specific virtual item, etc.). The events may be pre-defined within an XR interactivity framework comprised of a combination of triggers and actions.

Table 4 illustrates an example semantic of actions related to a modification of the user capability at runtime.

TABLE 4
Semantic of actions related to a modification of the user capability at runtime.

| Name | Type | Default | Usage | Description |
|---|---|---|---|---|
| userRepresentationNode | Number | — | M | Index of the node related to the user |
| | | | | representation in the nodes array |
| capabilitiesBoundaryType | Number | 1 | M | Describes the boundaries type to be |
| | | | | used for the user representation |
| | | | | capabilities. |
| | | | | 0 = glTF mesh |
| | | | | 1 = Bounded volume |
| volumeType | Number | — | O | Describes the bounded volume type in |
| | | | | case “capabilitiesBoundaryType” is of |
| | | | | type “bounded volume” |
| | | | | 0 = Cuboid |
| | | | | 1 = Sphere |
| volumeVertices | Array | — | O | Describes the vertices position for a |
| | | | | bounded volume type of Cuboid |
| volumeRadius | Number | — | O | Describes the radius for a bounded |
| | | | | volume type of Sphere |

The capabilities constraints may be provided to the XR application by adding a gITF extension at the user representation (e.g., avatar/camera) level with one or more of the following parameters. The capabilitiesBoundaries parameters may define the vertex coordinates of the boundaries expressed in the XR application world space. They may be provided through a mesh object in a gITF file. The mesh object may represent the bounded volume geometry. The coordinates may be provided through parameters expressing the bounded volume. There may be different types of bounded volumes, such as a cuboid, sphere, etc. For a cuboid, the parameters may be the vertices global position. For a sphere, the parameters may be the radius of the bounded sphere. A capabilities TimeBehavior parameter may define the time behavior of the boundaries using an enumeration or an explicit text between the static, timed or non-timed behaviors. If a timed capabilitiesTimeBehavior is defined, the timed data may be provided by one or more of the following. The timed data may be provided by a capabilitiesTimedAccessor parameter which indicates the related accessor in the gITF accessor array having a MPEG_accessor_timed extension or by a capabilitiesMediaSource parameter which indicates the related media in the MPEG_media extension. The capabilities TimedAccessor parameter may be used when the capabilities data evolves at each frame. The capabilitiesMediaSource parameter may be used when the capabilities data evolves at a pre-defined timestamp, such as a composition timestamp (CTS) (e.g., as shown in Table 5). The capabilities data related to the capabilitiesMediaSource parameter may be provided in a JSON file with a mimetype equal to “application/json.”

TABLE 5

| Name | Type | Default | Usage | Description |
|---|---|---|---|---|
| capabilitiesBoundaryType | Number | 1 | M | Describes the boundaries type to be |
| | | | | used for the capabilities user |
| | | | | representation space. |
| | | | | 0 = glTF mesh |
| | | | | 1 = Bounded volume |
| capabilitiesBoundaryMesh | Number | — | O | Index in the mesh array vertex positions |
| | | | | boundaries are used for defining the |
| | | | | boundaries when |
| | | | | “capabilitiesBoundaryType” is set to 0 |
| capablitiesVolumeType | Number | — | O | Describes the bounded volume type in |
| | | | | case “capabilitiesBoundaryType” is of |
| | | | | type “bounded volume” |
| | | | | 0 = Cuboid |
| | | | | 1 = Sphere |
| capabilitiesVolumeVertices | Array | — | O | Describes the vertices position for a |
| | | | | bounded volume type of Cuboid |
| capablitiesVolumeRadius | Number | — | O | Describes the radius for a bounded |
| | | | | volume type of Sphere |
| capabilitiesTimeBehavior | Number | 0 | M | Describes the time behavior of the user |
| | | | | representation capabilities. |
| | | | | 0 = Static |
| | | | | 1 = Timed |
| | | | | 2 - Non timed |
| capabilitiesTimedAccessor | Number | — | O | Provides the index of the accessor |
| | | | | having a timed extension in the |
| | | | | accessors array to read the per-frame |
| | | | | timed data |
| capabilitiesMediaSource | Number | — | O | Provides the index of the media in the |
| | | | | MPEG_media extension to read the |
| | | | | per-timestamp timed data |

```
“MPEG_DoF_constraints_from_user_representation_capabilities” : {
“capabilitiesBoundaryType” : #capabilitiesBoundaryType,
if (“capabilitiesBoundaryType “ == 0 ) {
  “capabilitiesBoundaryMesh”: #meshIndex
},
else if (“capabilitiesBoundaryType “ == 1) {
  “capabilitiesVolumeType” : #type_of_boundary_volume,
  if(“capabilitiesVolumeType “ == 0) {
    “capabilitiesVolumeVertices”: [ #Array_of_vertices]
  } else if ( “ capabilitiesVolumeType “ == 1) {
    “capabilitiesVolumeRadius” : #radius
  }
}
“capabilitiesTimeBehavior” : #capabilitiesTimeBehavior,
if (“capabilitiesTimeBehavior “ == 1 ) {
  “capabilitiesTimedAccessor”: #accessorIndex
  OR “capabilitiesMediaSource″: #mediaIndex
}
}
```

DoF constraints may be defined at runtime. One or more DoF constraints may be determined at runtime by the XR application using dedicated XR frameworks (e.g., OpenXR). In examples, the available space may be determined in which the user representation may move freely and safely when no scanned environment has been analyzed in a prior step (e.g., prior to runtime)

The application may rely on the OpenXR API and the GetReferenceSpaceBoundsRect( ) technique to calculate that available space.

In examples, a DoF constraint may be determined from both prior to runtime and at runtime information.

In examples, the available space in which the user may move freely and safely may be determined. The current user environment may be time-evolving and may have changed from the scanned data operation done prior to runtime (e.g., a table or a chair has been displaced). The related DoF boundaries may not be consistent between the pre-defined information (e.g., provided in the scene description file) and the runtime information (e.g., provided from the GetReferenceSpaceBoundsRect( ) OpenXR API).

A computation may be used to determine the final related DoF boundaries. Techniques may be used for the computation, for example: to not consider the DoF constraint determined prior to runtime and to take the most recent DoF constraint provided at runtime; and/or to take the common intersection volume between these 2 DoF constraints

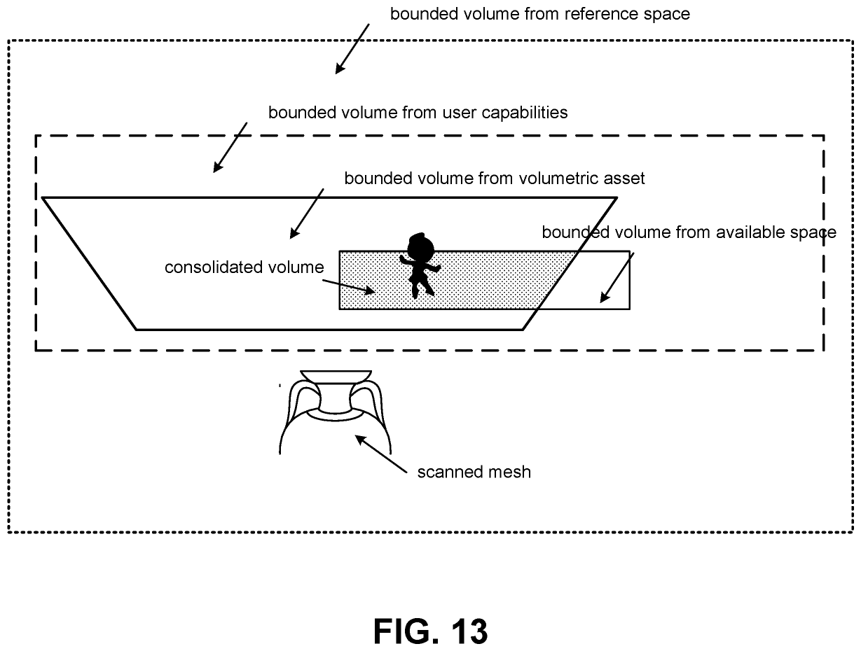

Computation of the consolidated DoF boundaries may be provided. The consolidated DoF boundaries for a user representation may correspond to the common intersection volume between the elementary boundaries (e.g., all the elementary boundaries) determined in techniques described herein, as shown in FIG. 13.

FIG. 13 shows an example of computation of the consolidated DoF boundaries. #The consolidated DoF boundaries may be computed, e.g., at the starting of the XR application if the elementary constraints are static or change periodically (e.g., at most every frame) for time-evolving or dynamic defined boundaries. #

If the computation of the consolidates boundaries for a user fails (e.g., if there is no common intersection volume between all the elementary boundaries), the XR application may launch a set of pre-defined boundary-failed action(s). The set of pre-defined boundary-failed actions may be defined within the interactivity framework.

For example, a boundary-failed action may be the display of an error message. A boundary-failed action may modify one or several elementary DoF boundaries to obtain a valid (e.g., non-null) consolidated DoF boundary, as for example: to inform the user to move or to re-arrange their real environment to enlarge/modify the available space constraint; to modify the pose or to not consider volumetric assets to modify/suppress their related DoF constraints; and/or to modify the DoF constraints related to the user representation capabilities. If there is no valid consolidated DoF boundary despite the boundary-failed action modification, an error message may be displayed before stopping the application.

A user may have dedicated boundary-failed actions. The dedicated boundary-failed actions may be referenced within the user representation (e.g., avatar/camera) gITF extension by adding a boundaryFailedActions parameter. The boundaryFailedActions parameter may include a set of numbers (e.g., of an array of integers). The set of numbers may correspond to the positions of the actions defined in the actions array of the interactivity framework. “boundaryFailedActions”: [1, 3]

Control of the user movements with respect to the consolidated DoF boundaries may be provided. An XR application may control the position of the user periodically (e.g., at most each frame) to check whether the user is located inside the consolidated DoF boundaries.

The determination of whether the user is located inside the consolidated DoF boundaries may be based on one or more user movements. The boundary checking may be performed (e.g., only performed) if a user movement (e.g., significant user movement) is detected. In examples, the XR application may rely on a trajectory prediction computation to determine in advance if the user is on the way to reach the consolidated boundaries.

Once the user reaches or is close to reaching the consolidated boundaries, the XR application may launch a set of boundary-reached actions (e.g., pre-defined boundary-reached actions). The set of boundary-reached actions may be defined within the interactivity framework. The set of boundary-reached actions may include one or more of the following: a progressive transition to a black screen rendering; a display of a warning message; haptic vibration signals; or an audio signal.

A user may have dedicated boundary-reached actions. The actions may be referenced within the previous user representation/camera gITF extension by adding a boundaryReachedActions parameter. The boundaryReachedActions parameter may include a set of numbers (e.g., an array of integers). The set of numbers may correspond to the positions of the actions defined in the actions array of the interactivity framework, as follows:
“boundaryReachedActions”: [0, 2]

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1.-18. (canceled)

19. A device comprising:
a processor configured to:
determine a first elementary degree of freedom (DoF) boundary associated with a user, wherein the first elementary DoF boundary is determined based on at least one of prior-to-runtime information or runtime information;
determine a second elementary DoF boundary associated with the user, wherein the second elementary DoF boundary is determined based on at least the prior-to-runtime information or the runtime information;
determine a consolidated DoF boundary based on the first elementary DoF boundary and the second elementary DoF boundary; and
on a condition that the determination of the consolidated DoF boundary is successful, determine to control a movement of the user based on the consolidated DoF boundary.

20. The device of claim 19, wherein on a condition that the determination of the consolidated DoF boundary is not successful, the processor is further configured to modify the first elementary DoF boundary or the second elementary DoF boundary to obtain a modified DoF boundary.

21. The device of claim 2, wherein the processor is further configured to:
determine an updated consolidated DoF boundary based on the modified DoF boundary and the first elementary DoF boundary or the second elementary DoF boundary.

22. The device of claim 21, wherein the processor is further configured to:
determine the modified DoF boundary by determining not to consider a volumetric asset of one or more of the first elementary DoF boundary or the second elementary DoF boundary.

23. The device of claim 21, wherein the processor is further configured to:
determine the modified DoF boundary by modifying a space constraint associated with the first elementary DoF boundary or the second elementary DoF boundary.

24. The device of claim 20, wherein on a condition that the determination of the consolidated DoF boundary is not successful, the processor is further configured to launch a boundary-failed action, wherein the boundary-failed action comprises one or more of an error message generation or a pre-defined boundary-failed action associated with the user.

25. The device of claim 19, wherein on a condition that the determination of the consolidated DoF boundary is not successful, the processor is further configured to modify a virtual item within an XR environment associated with the user.

26. The device of claim 19, wherein the processor configured to determine the consolidated DoF boundary based on the first elementary DoF boundary and the second elementary DoF boundary comprises the processor being configured to:
determine that a first physical environment of the first elementary DoF boundary and a second physical environment of the second elementary DoF boundary are different; and
based on the difference, determine to disallow the first elementary DoF boundary in the consolidated DoF boundary.

27. The device of claim 19, wherein the processor configured to determine the consolidated DoF boundary based on the first elementary DoF boundary and the second elementary DoF boundary comprises the processor being configured to:
determine that a first physical environment of the first elementary DoF boundary and a second physical environment of the second elementary DoF boundary are different; and
based on the difference, determine the consolidated DoF boundary based on a common intersection of the first elementary DoF boundary and the second elementary DoF boundary.

28. The device of claim 19, wherein on a condition that the user reaches the consolidated DoF boundary, the processor is further configured to launch a boundary-reached action, and wherein the boundary-reached action comprises one or more of: a progressive transition to a black screen rendering, a display of a warning message, a haptic vibration signal, an audio signal, or a user boundary-reached action.

29. A method comprising:
determining a first elementary degree of freedom (DoF) boundary associated with a user, wherein the first elementary DoF boundary is determined based on at least one of prior-to-runtime information or runtime information;
determining a second elementary DoF boundary associated with the user, wherein the second elementary DoF boundary is determined based on at least the prior-to-runtime information or the runtime information;
determining a consolidated DoF boundary based on the first elementary DoF boundary and the second elementary DoF boundary; and
on a condition that the determination of the consolidated DoF boundary is successful, determining to control a movement of the user based on the consolidated DoF boundary.

30. The method of claim 29, wherein on a condition that the determination of the consolidated DoF boundary is not successful, the method further comprises modifying the first elementary DoF boundary or the second elementary DoF boundary to obtain a modified DoF boundary.

31. The method of claim 30 further comprising determining an updated consolidated DoF boundary based on the modified DoF boundary and the first elementary DoF boundary or the second elementary DoF boundary.

32. The method of claim 31 further comprising determining the modified DoF boundary by determining not to consider a volumetric asset of one or more of the first elementary DoF boundary or the second elementary DoF boundary.

33. The method of claim 31 further comprising determining the modified DoF boundary by modifying a space constraint associated with the first elementary DoF boundary or the second elementary DoF boundary.

34. The method of claim 30, wherein on a condition that the determination of the consolidated DoF boundary is not successful, the method further comprises launching a boundary-failed action, wherein the boundary-failed action comprises one or more of an error message generation or a pre-defined boundary-failed action associated with the user.

35. The method of claim 29, wherein on a condition that the determination of the consolidated DoF boundary is not successful, the method further comprises modifying a virtual item within an XR environment associated with the user.

36. The method of claim 29, wherein determining the consolidated DoF boundary based on the first elementary DoF boundary and the second elementary DoF boundary comprises:
determining that a first physical environment of the first elementary DoF boundary and a second physical environment of the second elementary DoF boundary are different; and
based on the difference, determining to disallow the first elementary DoF boundary in the consolidated DoF boundary.

37. The method of claim 29, wherein determining the consolidated DoF boundary based on the first elementary DoF boundary and the second elementary DoF boundary comprises:
determining that a first physical environment of the first elementary DoF boundary and a second physical environment of the second elementary DoF boundary are different; and
based on the difference, determining the consolidated DoF boundary based on a common intersection of the first elementary DoF boundary and the second elementary DoF boundary.

38. The method of claim 29, wherein on a condition that the user reaches the consolidated DoF boundary, the method further comprises launching a boundary-reached action, and wherein the boundary-reached action comprises one or more of: a progressive transition to a black screen rendering, a display of a warning message, a haptic vibration signal, an audio signal, or a user boundary-reached action.
